(19) United States
(12) Patent Application Publication
(10) Pub. No.: US 2005/0229045 A1
(43) Pub. Date: Oct. 13, 2005

(54) Method and device for managing software error

(75) Inventor: Yasushi Tamakoshi, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/048,765

(22) Filed: Feb. 3, 2005

(30) Foreign Application Priority Data
Feb. 16, 2004 (JP) 2004-038416

(51) Int. Cl. G06F 11/00

(52) U.S. Cl. 714/38

(57) ABSTRACT

According to the importance levels of bugs and information for progress of correction for the bugs, a bug for which priority in problem solution is to be given is chosen. In an original source code, a search is performed to the whole original source code for a character sting written in a bug form and expressing the bug, thereby identifying locations in which bugs in the same type might exist. Furthermore, a search for a correction location in a corrected source code is performed and correction contents are verified with reference to the bug form and the retrieved correction location in the corrected source code.

### CROSS-REFERENCE TO RELATED APPLICATION

The disclosure of Japanese Patent Application No. 2004-38416 filed on Feb. 16, 2004 including specification, drawings and claims are incorporated herein by reference in its entity.

### BACKGROUND OF THE INVENTION

The present invention relates to a method for managing software errors in software development processes, and particularly relates to progress management for bug correction.

In a known software development project, there has been used a quality problem follow-up method and a support system which provide support for preventing re-occurrence of an inconvenience that has once occurred, in view of quality management (e.g., see Japanese Laid-Open Publication No. 2003-187069).

### SUMMARY OF THE INVENTION

However, the known technique has the following problems. In many cases, hundreds or a large number of bugs are discovered in a system test process, i.e., a lower process of development in a software development project. In the software development project, as a matter of course, it is necessary to identify causes of bugs one by one and correct errors in software. However, it is not effective if the existence of other similar bugs is overlooked and different measures are developed for different bugs, respectively, on by one.

In view of the problem described above, the present invention has been devised. It is therefore an object of the present invention to improve software development man-hours, especially, for debugging, by choosing similar bugs to a bug to which priority in problem resolution is to be given and making a measure for the bugs to correct errors.

To resolve the problems described above, according to the present invention, a method for managing software errors includes the steps of: rearranging a plurality of electric bug forms in order of a last update date from oldest; and rearranging the plurality of rearranged bug forms in order of an importance level from highest.

According to the present invention, the inventive method may further include the step of: rearranging the bug forms in order of the size of damage on progress of a progress due to bugs recorded in the bug forms from largest.

According to the present invention, the inventive method may further include the step of: rearranging the bug forms so that ones of the bug forms having a same cause category code are successively arranged.

According to the present invention, the inventive method may further include the steps of: recording in a bug form a partial bug character string discovered in a source code; and performing a search to the whole source code for the partial bug character string recorded in the bug form.

According to the present invention, the inventive method may further include the step of: recording a correction location of the partial bug character string in a corrected source code in which the partial bug character string has been corrected.

According to the present invention, a device for managing software errors includes: an arranger for rearranging a plurality of electric bug forms in order of a last update date from oldest; and an arranger for rearranging the plurality of rearranged bug forms in order of an importance level from highest.

According to the present invention, the inventive device may further include: an arranger for rearranging the bug forms in order of the size of damage on progress of a progress due to bugs recorded in the bug forms from largest.

According to the present invention, the inventive device may further include: an arranger for rearranging the bug forms so that ones of the bug forms having a same cause category code are successively arranged.

According to the present invention, the inventive device may further include: recorder for recording in a bug form a partial bug character string discovered in a source code; and a searcher for performing a search to the whole source-code for the partial bug character string recorded in the bug form.

According to the present invention, the inventive device may further include: a recorder for recording a correction location of the partial bug character string in a corrected source code in which the partial bug character string has been corrected.

As has been described, according to a method and a device for managing software errors according to the present invention, progress of a bug correction process can be precisely understood. Therefore, bugs of the same type can be discovered in a simple manner by understanding contents of bug correction.

### BRIEF DESCRIPTION OF THE DRAWINGS

FIG. 1 is a diagram illustrating a software development process according to an embodiment of the present invention.

FIG. 2 is a diagram illustrating a bug form according to an embodiment of the present invention.

FIG. 3 is a diagram illustrating a bug database according to an embodiment of the present invention.

FIG. 4 is a bug cause category table according to an embodiment of the present invention.

FIG. 5 is a diagram illustrating bug cause category input according to an embodiment of the present invention.

FIG. 6 is a table showing evaluation of damage amount according to an embodiment of the present invention.

FIG. 7 is a diagram illustrating a method for creating a bug progress management table according to an embodiment of the present invention.

FIG. 8 is a diagram illustrating a method for performing a search for bug character string according to an embodiment of the present invention.

FIG. 9 is a diagram illustrating a method for performing a search for a correction location according to an embodiment of the present invention.

### DESCRIPTION OF THE PREFERRED EMBODIMENTS

Hereinafter, embodiments of the present invention will be described with reference to the accompanying drawings. Preferred embodiments described in the following are not more than examples of the present invention and no way intended to limit the present invention and application or use of the present invention.

(1) Software Development Process

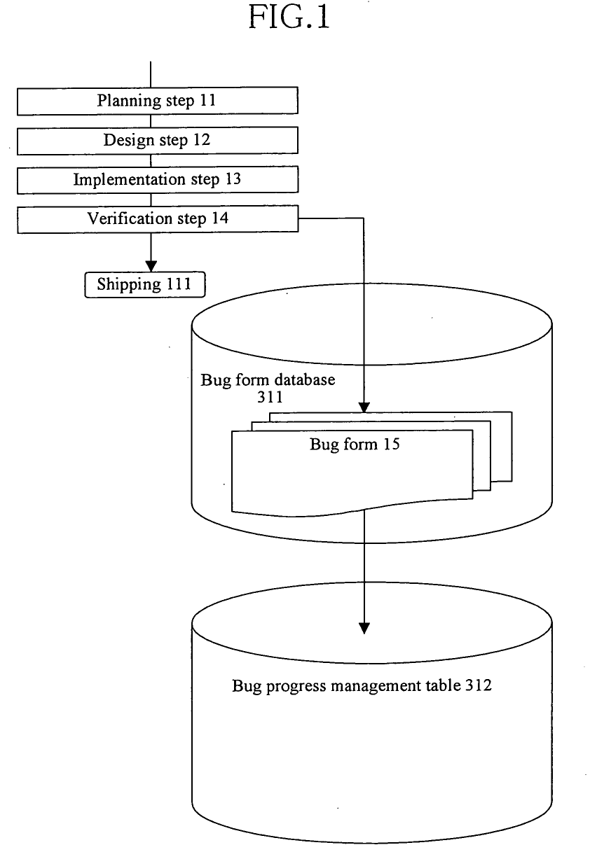

FIG. 1 is a diagram illustrating a software development process using a device for analyzing software errors according to one embodiment of the present invention. In general, a software development process can be described using a so-called waterfall model in which development process proceeds in one direction. The waterfall model includes a planning step 11, a design step 12, an implementation step 13 and a verification step 14. It should be noted that a spiral model in which perfection of a system is improved by repeating the design step 12, the implementation step 13 and the verification step 14 while development process proceeds can be considered to be a modified form of the waterfall model.

Inappropriate design or implementation discovered in each process of a software development project is called a bug. In general, the later a process step in which bugs are discovered is, the higher costs for correction become. That is, in terms of costs, it is ideal that bugs are discovered and corrected in a process step in which the bugs have are mixed in. Bugs discovered in a system test in the verification step 14, i.e., a lower process in a software development process might turn back not only to the implementation step 13 of performing coding but also to the design step 12 of performing designing at the abstract level or even to the planning step 11 of defining requirements depending on the case. This causes large damage on a software development project in terms of development costs.

Bugs discovered in the system test of the verification step 14 are electrically recorded in a format called bug form 15.

If bugs are no longer discovered in the system test of the verification step 14, the software development project is completed and then completed software is shipped 111.

(2) Bug Form

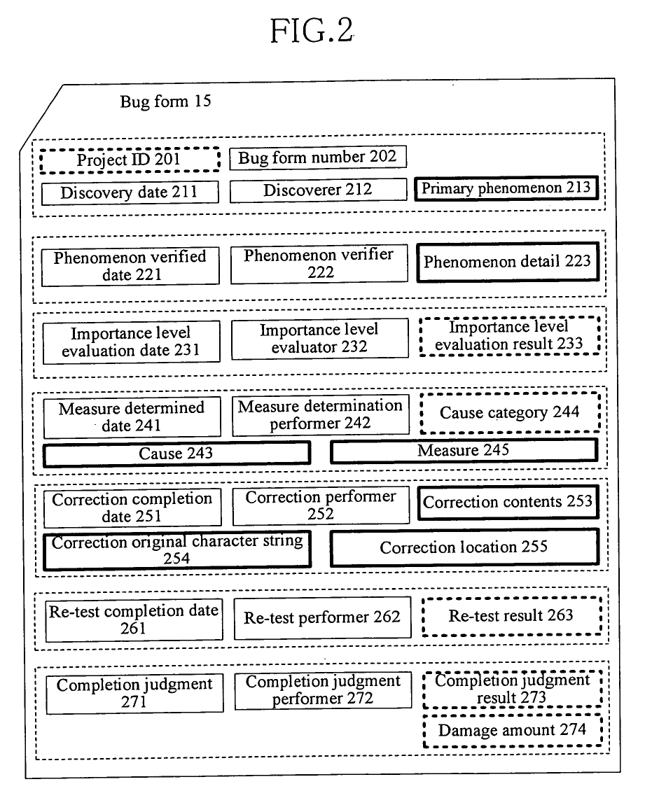

Hereinafter, a format of the bug form 15 and a bug correction process according to this embodiment will be described with reference to FIG. 2.

When a bug is discovered in the system test of the verification step 14, the bug form 15 is created by recording a project ID 201, a bug form number 202, a discovery date 211, a discoverer name 212 and a primary phenomenon 213. Then, when the primary phenomenon 213 is verified, the bug is identified by recording the phenomenon verified date 221, a phenomenon verifier name 222 and phenomenon details 223.

Next, when the level of importance of the bug is evaluated, priority in correction is determined by recording an importance level evaluation date 231, an importance level evaluation grader name 232 and an importance level evaluation result 233. Then, when cause and correction measure for the bug are identified, correction is started by recording a measure determined date 241, a measure determination performer name 242, a cause 243, a cause category 244 and a measure 245. When the correction is completed, a re-test is started by recording a correction completion date 251, a correction performer name 252, correction contents 253, a correction original character string 254, and a correction location 255. Furthermore, when the re-test is completed, completion judgment is started by recording a re-test completion date 261, a re-test performer name 262, and a re-test result 263. Then, when a completion judgment is performed, the correction process of the bug is terminated by recording a completion judgment date 271, a completion judgment performer name 272, a completion judgment result 273, and a damage amount 274.

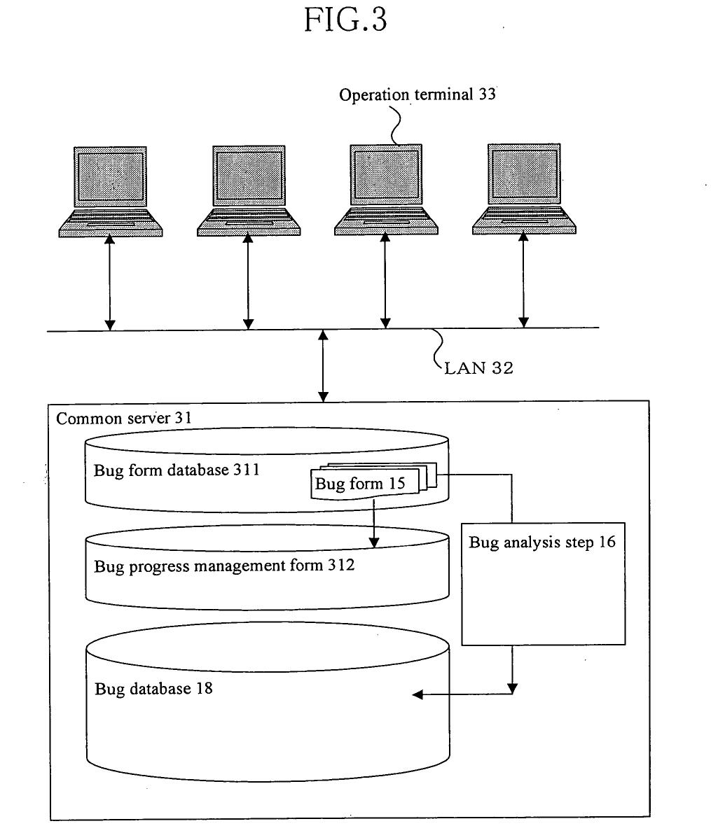

As shown in FIG. 3, in this embodiment, the bug form 15 is stored in a bug form database 311 provided on a common server 31 in the software development project. The common server 31 is accessible from an operation terminal 33 of each member of the software development project via a LAN 32. The common server 31 includes a bug form database 311, a bug progress management table 312, and a bug database 18. As described in the following, each member of the software development project accesses the bug database 311 and writes predetermined information in an electronic bug form 15.

When a system test performer discovers a bug in the system test of the verification step 14, the person logs in a tested system and selects a menu for bug form creation as shown in FIG. 2. Then, information for the discovery date 211 and the discoverer name 212 is automatically input from time information of the system and log-in information, respectively. Moreover, a project which the system test performer corresponding to the discoverer name 212 handles is displayed as a menu, and the system test performer selects the project ID 201 and inputs information for the project ID 201. When the project ID 201 is determined, a bug form number 202 is added and information for the bug form number 202 is automatically input. Thereafter, the system test performer inputs information for the primary phenomenon 213. In the manner described above, the bug form 15 is created.

Next, when the bug form 15 has been created, the created bug form information is mail transmitted to developer members of the project corresponding to the project ID 201. When a developer member of the project verifies the primary phenomenon 213 in a development environment, the member logs in the system and selects a menu for phenomenon verification. Then, information for the phenomenon verification date 221 and the phenomenon verifier name 222 is automatically input from the time information of the system and the log-in information, respectively. Moreover, the developer member inputs information for the phenomenon detail 223. In the manner described above, the bug is identified.

Next, when the bug has been identified, the completed bug form information is mail transmitted to a project leader of the project corresponding to the project ID 201 and a representative for the project leader. When the project leader of the project or the representative for the project leader evaluates the level of importance of the bug, the project leader of the project or the representative logs in the system and selects a menu for importance level evaluation. Then, information for the importance level evaluation date 231 and the importance level evaluation grader name 232 is automatically input from the time information of the system and the log-in information, respectively. Moreover, the project leader or the representative for the project leader selects and inputs information for the importance level evaluation result 233 from the menu.

Then, the completed bug form information is mail transmitted to the project leader of the project corresponding to the project ID 201 and the representative for the project leader and is also displayed in a bug progress management table 312 which will be described later with reference to FIG. 3. All members of the software development project can refer to the bug progress management table 312. In the bug progress management table 312, besides a progress state, information recorded in the bug form including the importance level evaluation result for the bug is displayed. A progress state of a bug that has been just identified is indicated as “under investigation”.

Next, the developer member of the project corresponding to the project ID 201 pursues a cause for the bug and plans a correction proposal. When the developer member of the project pursues a cause for the bug and plans a correction proposal, the developer member logs in the system and selects a menu for cause input. Then, information for the measure determined date 241 and the measure determination performer name 242 is automatically input from the time information and the log-in information, respectively. Thereafter, the developer member inputs information for the cause 243 and the measure 245 and selects and inputs the cause category 244 from a menu. Thus, the progress state of the bug is reflected in the bug progress management table 312 and the progress state of the bug is indicated as “correcting”.

Next, the developer member of the project corresponding to the project ID 201 performs correction. When the developer member of the project completes correction for the bug, the developer member logs in the system and selects a menu for correction completion. Then, information for the correction completion date 251 and the correction performer name 252 is automatically input from the time information of the system and the log-in information, respectively. Moreover, the developer member inputs information for the correction contents 253, the correction original character string 254, and the correction location 255. Thus, the progress state of the bug is reflected in the bug progress management table 312 and the progress state of the bug is indicated as “re-testing”.

Next, when the correction is completed, the completed bug form information is mail transmitted to the system test performer handling the project ID 201. When the system test performer of the project has completed the re-test, the system test performer logs in the system and selects a menu for re-test. Then, information for the re-test completion date 261 and the re-test performer name 262 is automatically input from the time information of the system and the log-in information, respectively. Moreover, the system test performer selects and inputs information for the re-test result 263 from a menu. Thus, the progress state of the bug is reflected in the bug progress management table 312 and the progress state is indicated as “under determination”.

Next, when the re-test is completed, the completed bug form information is mail transmitted to the project leader of the project corresponding to the project ID 201 and the representative for the project leader. When the project leader of the project or the representative for the project leader has performed completion judgment, the project leader or the representative logs in the system and selects a menu for completion judgment. Then, information for the completion date 271 and the completion judgment performer name 272 is automatically input from the time information of the system and the log-in information, respectively. Thereafter, the project leader or the representative inputs information for a completion judgment result 273 and a damage amount 274. Thus, the progress state of the bug is reflected in the bug progress management table 312 and the correction process for the bug is completed.

Note that in FIG. 2, an automatic input portion, a menu input portion and a manual input portion by a user are expressed by a thin line, a thick broken line and a thick solid line, respectively.

(3) Omission of Bug Form Items

In the description above, the items of the bug form 15 in this embodiment have been shown. However, depending on an adopted software development standard, the bug form 15 used therein does not have to include all of the items described above. The bug form 15 including part of the items described above may be also used. In such a case, the bug correction process described above is partially omitted. It should be noted that the cause category 244 is a necessary item.

Moreover, in damage evaluation which will be described later, if the damage amount 274 is used, the damage amount 274 is a necessary item. Furthermore, if the number of days required for bug correction is used, the discovery date 211 and the completion judgment date 271 are necessary items. Depending on a software development standard to be adopted, the phenomenon verified date 221, instead of the discovery date 211, may be used as a necessary item, and the re-test completion date 261 and the correction completion date 251, instead of the completion judgment date 271, may be used as necessary items.

(4) Cause Categorization

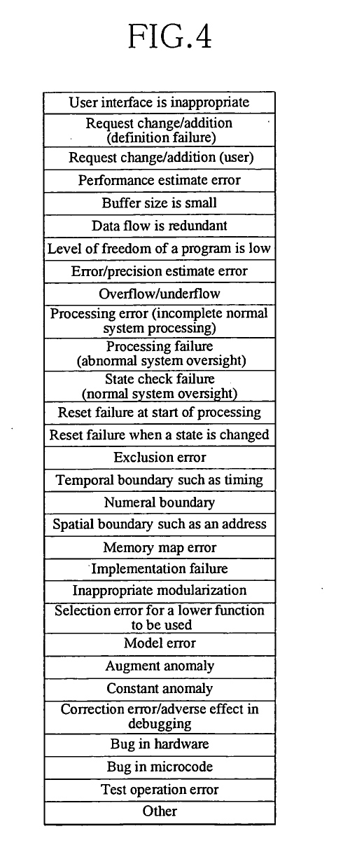

Categories for the cause category 244 of the bug form 15 in this embodiment are shown in a category table of FIG. 4. As for the cause category 244, categorization is performed using direct technical causes so as to link bugs to technical measures in a software development process.

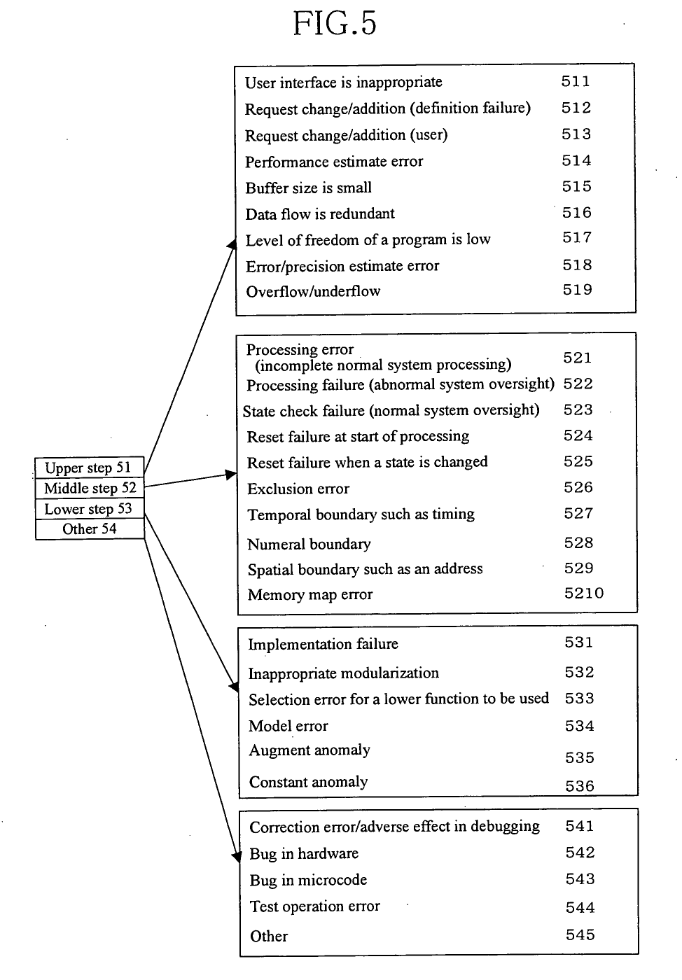

Hereinafter, with reference to FIG. 5, a cause input method according to this embodiment will be described. In inputting information for the cause category 244, a major category to be used in a software development process and the like is selected using a menu. Specifically, a user makes a selection from four categories, i.e., an upper process 51 such as request analysis, system designing and software architecture designing, a middle process 52 such as software function designing and software module designing, and a lower process 53 such as coding, and other 54 such as an error of test and a bug in software. When the major category has been selected, a menu including detail categories is continuously displayed. Herein, a detail category is a bug technical cause included in a major category in the software development process.

When the upper process 51 for the major category is selected, as detail categories, inappropriate 511, request change/addition (definition failure) 512, request change/addition (user) 513, performance estimate error 514, buffer size is small 515, data flow is redundant 516, the level of freedom of a program is low 517, error/precision estimate error 518 and overflow/underflow 519 are displayed in a menu, and the user selects one from the menu.

When the middle process 52 for the major category is selected, as detail categories, processing error (incomplete normal system processing) 521, processing failure (abnormal system oversight) 522, state check failure (normal system oversight) 523, reset failure at start of processing 524, reset failure when a state is changed 525, exclusion error 526, temporal boundary such as timing 527, numeral boundary 528, spatial boundary such as an address 529, memory map error 5210 are displayed in a menu, and the user selects one from the menu.

When the lower process 53 for the major category is selected, as detail categories, implementation failure 531, inappropriate modularization 532, selection error for a lower function to be used 533, model error 534, augment anomaly 535, and constant anomaly 536 are displayed in a menu, and the user selects one from the menu.

When other 54 for the major category is selected, as detail categories, correction error/adverse effect in debugging 541, bug in hardware 542, bug in microcode 543, test operation error 544, and other 545 are displayed in a menu, and the user selects one from the menu.

In this embodiment, as has been described, a total of about 30 types of bug technical causes are set as detail categories, and the detail categories are divided into four major categories. When the present invention is implemented, bug technical causes may be categorized in further detail within a range in which selection does not become complicated. In contrast, when there is some detail category considered to hardly occur as a bug technical cause, the detail category may be omitted from the detail category menu. However, it is not preferable to roughly set categories for the detail categorization because planning of a technical measure becomes difficult.

(5) Evaluation of Damage Amount

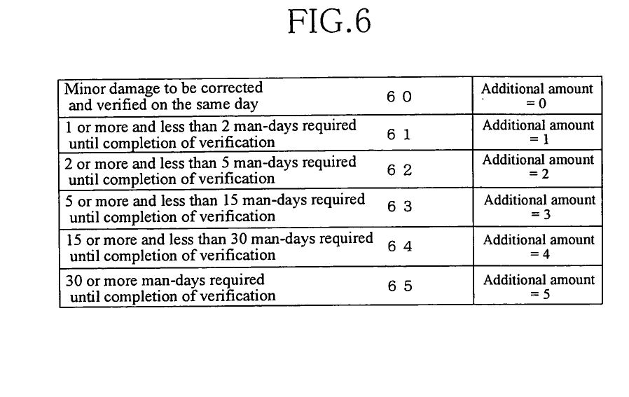

Next, a method for evaluating a damage amount in this embodiment of the present invention will be described with reference to FIG. 6. A user evaluates a damage given to a software development project by each bug and inputs an evaluation result into the damage amount 274 in the bug form 15. The damage is mainly a loss of man-hour/day for development but, for example, not a loss paid as a result of a bug.

In this embodiment, the following menu is displayed when input for the damage amount 274 is performed. Specifically, damages due to bugs are categorized into 6 stages, i.e., minor damage to be corrected and verified on the same day 60, 1 or more and less than 2 man-days were required until completion of verification 61, 2 or more and less than 5 man-days were required until completion of verification 62, 5 or more and less than 15 man-days were required until completion of verification 63, 15 or more and less than 30 man-days were required until completion of verification 64 and 30 or more man-days were required until completion of verification 65.

For each bug technical cause, as a damage, 0 is added to the damage amount for the bug cause if the damage is minor damage to be corrected and verified on the same day 60, 1 is added to the damage amount of the bug cause if one or more and less than two man-days were required until completion of verification 61, 2 is added to the damage amount of the bug cause if two or more and less than 5 man-days were required until completion of verification 62, 3 is added to the damage amount of the bug cause if 5 or more and less than 15 man-days were required until completion of verification 63, 4 is added to the damage amount of the bug cause if 15 or more and less than 30 man-days were required until completion of verification 64, and 5 is added to the damage amount of the bug cause if 30 or more man-days were required until completion of verification 65.

A method for evaluating a damage amount according to a different embodiment of the present invention from the one described above will be described with reference to FIG. 2.

The number of days from the discovery date 211 to the completion judgment date 271 described in the bug form 15 is added to the damage amount of the bug cause given to a project. In this embodiment, as a method for calculating the number of days from the discovery date 211 to the completion judgment date 271, merely, calendar days are used. However, the number of workdays of the project may be separately defined on the calendar so as to calculate the number of workdays excluding non-workdays such as holidays.

(6) Database Storage

Next, a method for storing a database according to an embodiment of the present invention will be described with reference to FIG. 1 and FIG. 3. Each member of a software development project can access the bug form database 311, the bug progress management table 312 and the bug database 18 provided on the common server 31 from the operation terminal 33 of each member via a LAN 32.

As has been described, when a bug is discovered, the bug form 15 is raised in the bug form database 311 and necessary items are written in the bug form 15 in order. Accordingly, as many bug forms 15 as the number of bugs are stored in the bug form database 311.

In each of bug forms 15 for the same project, the same value is described for the project ID 201.

(7) Creation of Bug Progress Management Table

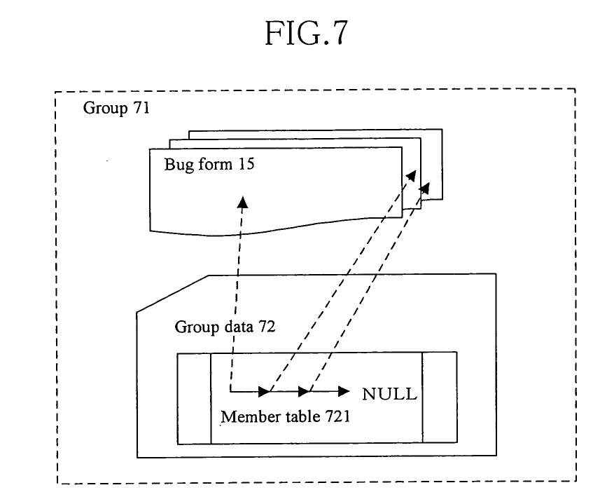

A method for creating the bug progress management table 312 according to an embodiment of the present invention will be described with reference to FIG. 1 and FIG. 7. The bug progress management table 312 is a table in which information written in a bug form 15 is arranged so that the written information can be seen in a list. In this embodiment, the arrangement order of bug forms 15 is important.

First, of the bug forms 15, bug forms 15 including the same information for the cause category 244 are collected as a group 71. In this case, the group 71 includes group data 72. The group data 72 includes a member table 721. Note that as many groups 71 as the number of different information types for the cause category 244 exist at most.

The bug form number 202 of each of the bug forms 15 including the same information for the cause category 244 is written in the member table 721 in order. In this case, the member table 721 is in a list format.

Next, the bug forms 15 written in the member table 721 are re-arranged in order of a last update date from oldest. Specifically, if the completion judgment date 271 is written in the bug form 15, the completion judgment date 271 is used as the last update date. Furthermore, if the completion judgment date 271 is blank, the re-test completion date 261 is referred to and, if the re-test completion date 261 is written in the bug form 15, the re-test completion date 261 is used as the last update date. Furthermore, if the re-test completion date 261 is blank, the correction completion date 251 is referred to and, if the correction completion date 251 is written in the bug form 15, the correction completion date 251 is used as the last update date. Furthermore, if the correction completion date 251 is blank, the measure determined date 241 is referred to and, if the measure determined date 241 is written in the bug form 15, the measure determined date 241 is used as the last update date. Furthermore if the measure determined date 241 is blank, the importance level evaluation date 231 is referred to and, if the importance level evaluation date 231 is written in the bug form 15, the importance level evaluation date 231 is used as the last update date. Furthermore, if the importance level evaluation date 231 is blank, the phenomenon verified date 221 is referred to and, if the phenomenon verified date 221 is written in the bug form 15, the phenomenon verified date 221 is used as the last update date. Furthermore, if the phenomenon verified date 221 is blank, the discovery date 221 is used as the last update date. Thus, a bug form 15 of which the last update date is the oldest is the first bug form 15 in the member table 721.

Next, the bug forms 15 written in the member table 721 are re-arranged in order of the importance level from highest. Specifically, the importance level evaluation result 233 written in each bug form 15 is referred to. For bug forms 15 for which importance level evaluation is not completed, a lowest importance level is used.

By performing the above-described re-arrangement of the bug forms 15, a bug form 15 which has the highest important level in the group 71 or of which progress has not been made for a longest period of time among bug forms 15 having the same importance level becomes the first bug form 15 in the member table 721.

(8) Search for Bug Character String

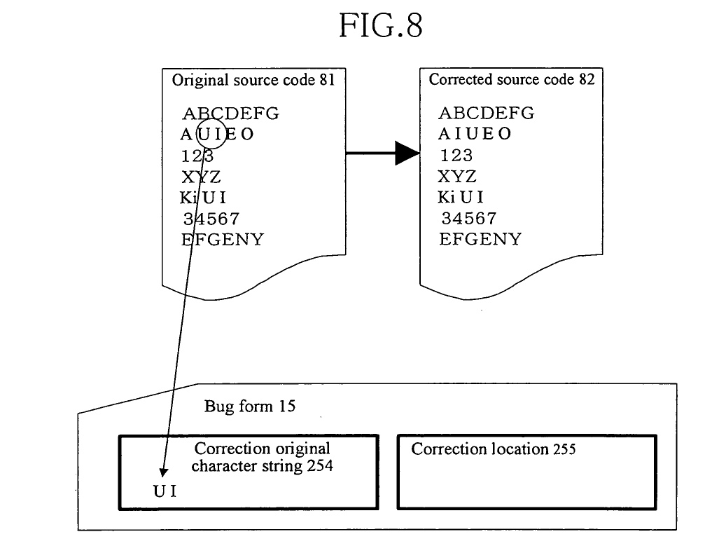

Next, a method for performing a search for a bug character string according to an embodiment of the present invention will be described with reference to FIG. 8. First, a search is performed using an editor and the like to a whole original source code 81 to retrieve a character sting written in the correction original character string 254 of a bug form 15. Thus, it becomes possible to point out a location(s) in which a bug(s) of the same type might exist in the original source code 81.

In this manner, a correction performer corrects a bug, so that the correction performer can identify a character string in a location in which a bug is present in the original source code 81. In the example of FIG. 8, the correction performer considers a character string “UI” as a character sting of a bug. In this example, for example, “AUIEO” may be considered to be a character string of the bug. In this case, to retrieve another bug of which a character string includes the same error as that of the character string of the bug, an appropriate character string has to be chosen.

Then, in the original source code 81, a character string which expresses characteristics of the bug well and is considered to be commonly included in other bugs of the same type is input and recorded as the correction original character string 254. An OS of personal computer as an operation terminal or a character string copy function in an editor is used for the input operation for a bug character string.

(9) Search for Collection Location

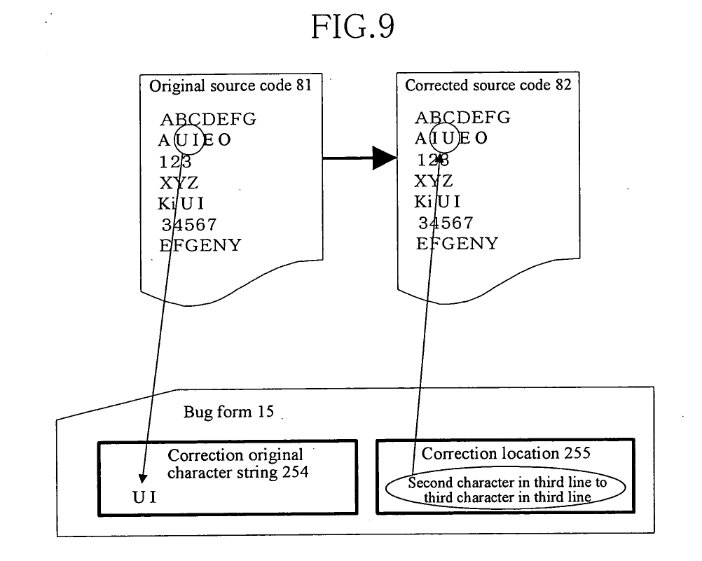

Next, a method for performing a search for a correction location according to an embodiment of the present invention will be described with reference to FIG. 9. First, location information written in the correction location 255 of a bug form 15 is displayed by an editor or the like. Thus, a correction location in a corrected source code 82 can be referred to.

In this manner, a correction performer corrects a bug, so that the correction performer can identify a correction location in the corrected source code 82 obtained by correcting the original source code 81. In the example of FIG. 9, the correction performer considers “IU”, i.e., the second character in the third line to the third character in the third line as a correction location. In this example, for example, “AIUEO” may be considered to be a correction location. In this case, an appropriate location has to be indicated to express a correction location in the corrected source code 82 for the bug form 15.

Then, the correction location in the corrected source code 82 on the editor and a range of the correction are instructed, so that a correction location in a source code file and range information for the correction are input and recorded as the correction location 255. The character string location display function in an editor of personal computer as an operation terminal is used for the input operation for a correction location.

A method and a device for managing software errors according to the present invention are useful as tools for supporting improvement of processes of a software development project.

1. A method for managing software errors, the method comprising the steps of:
rearranging a plurality of electric bug forms in order of a last update date from oldest; and
rearranging the plurality of rearranged bug forms in order of an importance level from highest.

2. The method of claim 1, further comprising the step of: rearranging the bug forms in order of the size of damage on progress of a progress due to bugs recorded in the bug forms from largest.

3. The method of claim 1, further comprising the steps of: rearranging the bug forms so that ones of the bug forms having a same cause category code are successively arranged.

4. The method of claim 1, further comprising the step of: recording in a bug form a partial bug character string discovered in a source code; and
performing a search to the whole source code for the partial bug character string recorded in the bug form.

5. The method of claim 4, further comprising the step of: recording a correction location of the partial bug character string in a corrected source code in which the partial bug character string has been corrected.

6. A device for managing software errors, the device comprising:
an arranger for rearranging a plurality of electric bug forms in order of a last update date from oldest; and
an arranger for rearranging the plurality of rearranged bug forms in order of an importance level from highest.

7. The method of claim 6, further comprising: an arranger for rearranging the bug forms in order of the size of damage on progress of a progress due to bugs recorded in the bug forms from largest.

8. The device of claim 6, further comprising: an arranger for rearranging the bug forms so that ones of the bug forms having a same cause category code are successively arranged.

9. The device of claim 6, further comprising: a recorder for recording in a bug form a partial bug character string discovered in a source code; and
a searcher for performing a search to the whole source code for the partial bug character string recorded in the bug form.

10. The device of claim 9, further comprising: a recorder for recording a correction location of the partial bug character string in a corrected source code in which the partial bug character string has been corrected.
